(19) United States
(12) Patent Application Publication
(10) Pub. No.: US 2024/0229766 A9
(43) Pub. Date: Jul. 11, 2024

(54) METHOD FOR OPERATING A WIND TURBINE

(71) Applicant: Wobben Properties GmbH, Aurich (DE)

(72) Inventors: Michael Alletto, Bremen (DE); Marcus Letzel, Achim (DE)

(21) Appl. No.: 18/489,628

(22) Filed: Oct. 18, 2023

(30) Foreign Application Priority Data
Oct. 19, 2022 (EP) 22202512.4

(51) Int. Cl. F03D 7/02; F03D 7/04

(52) U.S. Cl. CPC F03D 7/0276; F03D 7/0224; F03D 7/049; F05B 2260/84; F05B 2270/204; F05B 2270/32; F05B 2270/321

(57) ABSTRACT

A method for operating a wind turbine for generating a settable turbine power, where the wind turbine includes a rotor having rotor blades adjustable in their blade angle, is operable at a settable rotor speed, and is installed at an installation site at a distance to an obstacle, comprises the obstacle causing a wind disturbance, which, in dependence on current wind direction and wind velocity, can reach the wind turbine as a wind wake, and the wind turbine reducing its turbine operation by throttling down for protection against loads due to the wind wake, wherein the throttling down is controlled in dependence on the current wind direction and the current wind velocity, wherein a weather prediction is used in order to take into consideration at least one further weather property in addition to the wind direction and wind velocity, and wherein the throttling down is additionally controlled in dependence on the weather prediction, in particular on the further weather property.

### BACKGROUND

### Technical Field

Embodiments of the present invention relate to a method for operating a wind turbine and to a corresponding wind turbine.

### Description of the Related Art

Wind turbines are known, they generate electric power from wind with the aid of an aerodynamic rotor. The wind turbine is also subjected to mechanical loads by the wind in this case. The wind turbine is designed in accordance with such mechanical loads, however, increased loads can occur due to turbulence of the wind. Such turbulence can arise due to obstacles which stand in front of the wind turbine with respect to the wind direction.

Such obstacles can be buildings and other wind turbines, but in particular can also be caused by the topography. Accordingly, corresponding mountains or hills come into consideration as natural obstacles, but also individual or multiple trees.

Since such turbulence is dependent on the wind direction, a load reduction can be provided depending on the wind direction. A procedure for protecting the wind turbine in the event of wind directions from which a strong strain of the wind turbine is to be expected is to apply sector management so that the wind turbine, which can also be designated in short as a turbine, reaches a desired service life. Sector management means here that the turbines are partially or entirely throttled down for load reduction, but only for a correspondingly relevant wind direction vector.

Such throttling down is accompanied by a reduction of the current production. The sector management works so that throttling down of the turbine, which can be fixedly specified, is provided for a given wind direction sector and a given wind velocity.

The disadvantage nonetheless results accordingly that a turbine is only throttled down for the wind direction sectors, or only for one wind direction sector, but this can nonetheless have significant losses in output.

### BRIEF SUMMARY

Some embodiments include a wind turbine where the wind turbine is to be protected from increased loads, with the least possible losses in output. In particular, the wind turbine is to be throttled down as little as possible for this purpose. An alternative to previously known solutions is at least to be proposed.

Some embodiments include related methods. The wind turbine is thus operated to generate a settable turbine power. This is based on a wind turbine which includes a rotor having rotor blades, wherein the rotor blades are adjustable in their blade angle. In addition, the wind turbine is distinguished by the fact that it is operable with a settable rotor speed. In addition, the wind turbine is distinguished by the fact that it is installed at an installation site at a distance to an obstacle.

The obstacle can basically be anything which is large enough to influence the wind accordingly. In addition to topographic features such as a hill or a mountain, a tree or a forest, buildings also come into consideration and other wind turbines also come into consideration. In this case, these other wind turbines, wherein of course only a single one of them also comes into consideration, can be installed in the same wind park as the wind turbine to be operated. The installation in a common wind park is not required, however. It is also conceivable that the wind turbine to be operated and the wind turbine which forms an obstacle are individual turbines and/or feed into an electrical supply grid independently of one another.

An obstacle is only one which can cause a wind disturbance which can reach the wind turbine as a wind wake depending on the current wind direction and wind velocity. If a supposed obstacle is thus far enough away or small enough that it cannot cause a wind disturbance which also reaches the wind turbine to be operated, it is not an obstacle in the meaning of the present disclosure or is not considered.

It is now provided that the wind turbine reduces its turbine operation by throttling down for protection against loads due to the wind wake. If the wind wake and thus the wind disturbance therefore reach the wind turbine, it can reduce its turbine operation, which is designated as throttling down, and is thus not loaded as strongly and is therefore protected against loads due to the wind wake.

The throttling down takes place in dependence on the current wind direction and the current wind velocity. Throttling down thus only takes place when the wake can reach the wind turbine at all due to the current wind direction and the throttling down is also only controlled when the current wind velocity is strong enough that the wake reaches the wind turbine and/or the turbulence is strong enough at all that a protection of the wind turbine against it is necessary.

In addition, it is proposed that a weather prediction be used. This is used to take into consideration at least one further weather property in addition to the wind direction and wind velocity. Since wind direction and wind velocity can also be viewed as weather properties, at least one third weather property is therefore taken into consideration. Wind directions and wind velocities do not necessarily have to be taken into consideration by the weather prediction, however.

For this purpose, it is then proposed that the throttling down additionally be controlled in dependence on the weather prediction, in particular namely on the at least one further weather property. The throttling down is thus controlled in dependence on the wind velocity, the wind direction, and the at least one further weather property. The at least one further weather property, which can be a thermal air stratification, for example, is supplied here by the weather prediction.

It was especially recognized here that the length of the circulation regions behind mountains, buildings, and other flow obstacles and also the length of the wakes behind wind turbines, which can also be designated as wind power plants, is caused by the thermal stratification of the atmospheric boundary layer.

With stable stratification, which is characterized by low turbulence and therefore less mixing, wakes of turbines are longer than with labile stratification. However, the specific behavior can also be dependent on the specific topography.

Labile stratification is characterized by strong mixing.

The size of the recirculation regions behind mountains is also dependent on the stratification. With stable stratification, the buoyancy has the result that strong detachment of the flow is prevented. In this case, the buoyancy force points in the direction of gravity. Inverse effects occur with labile stratification. Wakes behind turbines and recirculation regions of obstacles are accompanied by strong shear layers. Turbines which are subjected to strong shear layers are strained by strong periodic loads.

It is therefore proposed that especially such thermal stratification be taken into consideration and this be obtained by the weather prediction. Although the thermal stratifications can be in the foreground in the proposed consideration, other weather properties also come into consideration, which can influence the strength of the wind disturbances at the turbine and/or the length of the wakes. It can therefore be advantageous to also take into consideration other weather properties additionally or alternatively to the thermal layers.

It has also been recognized that such further weather properties can be recognized as well or better by weather predictions than by measuring them. It has also been recognized that a certain time can pass until the wind disturbances arising at an obstacle reach the turbine. The at least one further weather property insofar does not necessarily act immediately, so that it is advantageous to take it into consideration early via the weather prediction. It has also been recognized that some weather properties, which applies especially for the thermal stratification, can be depicted well by weather predictions. Moreover, thermal stratifications are especially a larger-area phenomenon and often extend beyond the area between obstacle and turbine in their local propagation. This also suggests that they should be taken into consideration via a weather prediction. It also comes into consideration for other weather properties.

A front passage can be viewed as a further example of a weather property, thus the passage of a cold front or a warm front. Such front passages can be accompanied by a wind velocity jump and wind direction changes. Frequent, short rain showers can be a further example of a weather property. Frequent, short rain showers can be accompanied by very strong gusty wind. Both can influence the wakes and it is proposed according to one embodiment that at least one of these phenomena be taken into consideration in each case as a weather property.

Some embodiments may be based on the finding that phenomena harmful to turbines can be dependent in their spatial extension on the weather conditions. It is therefore proposed that weather forecasts also be incorporated in the sector management. It is therefore particularly proposed that the turbine only be throttled down at points in time at which it is subjected to harmful flow states. At points in time at which such harmful events do not occur, or the effect thereof on the service life of the turbine is minor, in particular is negligible, it is proposed that more power be produced by less restrictive sector management. The proposal described herein is therefore a weather-related regulation.

Such weather-related regulation has been recognized as particularly effective because there is an inversely exponential relationship between amplitude of the loads and number of the load cycles until a component failure. Therefore, several additional load cycles can already be possible with a somewhat lower amplitude of the load before a component failure occurs.

According to one aspect, it is proposed that the further weather property is estimated in dependence on the weather prediction and/or the further weather property is a thermal stratification of atmospheric boundary layers, and the throttling down is controlled in dependence on the thermal stratification.

It has therefore been recognized that the thermal stratification can have a strong influence on the propagation and also a possible change of the wind disturbance and/or the wake caused at the obstacle. It is therefore proposed that the throttling down be controlled in dependence on the thermal stratification in addition to the wind velocity and wind direction.

According to one aspect, it is proposed that the throttling down be controlled in dependence on the thermal stratification so that an area surrounding the wind turbine is classified as flat land or mountainous land. In particular, the area between wind turbine and an obstacle is classified. However, flat land typically does not change into mountainous land or vice versa in a very small space. The surrounding area can therefore also be viewed as an area having a radius of several kilometers around the wind turbine, in particular having a radius of at least 5 km, in particular of at least 10 km around the wind turbine. An area defined in this way can be classified as flat land if a maximum height difference of the Earth's surface in the area thus defined is at most 100 m, in particular at most 50 m.

The area can be classified as mountainous land if it was not classified as flat land.

For this purpose, it is furthermore proposed that if the land is classified as flat land, throttling down is carried out more the weaker mixing between boundary layers is and/or the more stable the thermal stratification is.

Vice versa, it is proposed that if the land is classified as mountainous land, throttling down is carried out less the weaker mixing is between boundary layers and/or the more stable the thermal stratification is.

In the case of weak mixing between boundary layers or a stable thermal stratification, clear thermal layers are therefore present. A lower air layer is especially present, which is colder and therefore heavier, thus has a higher density, than an air layer lying above it. A wind turbine then stands in the lower, colder air layer having the higher density.

For this purpose, it has been recognized that in flat terrain, such a cold air layer promotes the propagation of a wake, or at least does not obstruct it strongly. A wake then reaches the wind turbine to be throttled down more strongly, so that then in flat terrain the wind turbine is to be throttled down more strongly than in the case of such a stratification in mountainous land.

It has furthermore been recognized that in mountainous terrain, the lower cold air layer is more strongly influenced by weight force or buoyancy, because in mountainous land the weight force or the buoyancy acts in the flow direction or results in a flow. The heavy air is set into motion toward the lighter air here, which would occur less or not at all with strong mixing, because due to the uneven terrain, thus the non-horizontal terrain, the buoyancy of the lighter air or the downforce of the heavier air results in an air flow along the terrain ground. Such an air flow can result in damping of a wake and/or can prevent or weaken its occurrence. The opposite effect therefore results in mountainous land in relation to flat land and it is proposed that throttling down be carried out less accordingly if in mountainous land the mixing between boundary layers is weaker and/or the thermal stratification is more stable.

According to one aspect, it is proposed that for throttling down, the turbine power is reduced, the rotor speed is reduced, and/or the blade angle of each rotor blade is adjusted in the direction toward a vane position.

The load of the wind turbine can be reduced by these measures if the loads due to the wind wake have to be reduced. The load of the wind turbine as a whole is reduced with reduction of the turbine power, also the mechanical load, particularly that acting on the rotor. The rotor speed behaves similarly, so that it is proposed that one of the two be reduced. However, both can also be reduced together.

The rotor blade is especially loaded at wind velocities in the range of the nominal wind velocity, since the rotor blades have a blade angle here in normal operation which offers the largest attack area. By pivoting the blade angle in the direction toward the vane position, thus increasing the blade angle, this load can be reduced.

Two or all three possibilities may be combined. It comes into consideration in particular that less power is taken from the wind due to pivoting of the blade angle, so that the turbine power, in particular the power fed into the electrical supply grid, is also reduced.

The rotor speed can also be reduced in this case. It can be advantageous to set turbine power and rotor speed according to a speed-power characteristic curve, which can also be used in part-load operation. Less power is taken from the wind due to the adjustment of the rotor blades, so that a part-load situation more or less occurs from the viewpoint of the wind turbine, so that the mentioned speed-power curve can be used.

According to one aspect, it is proposed that a length of the wind wake be estimated in dependence on the weather prediction, in particular in dependence on the weather property, and the throttling down be controlled in dependence on the estimated length of the wind wake.

This is especially based on the idealizing consideration that depending on the weather prediction and thus the weather property, the wind wake, which otherwise endangers the turbine, can be so short that it does not reach the wind turbine. In this case, the wind turbine does not have to be throttled down, which it would otherwise have to do with corresponding wind direction and wind velocity.

It has been recognized that such a wind wake cannot be readily measured or a measurement would make a costly apparatus investment necessary. It is therefore proposed that this wind wake, including its length, be estimated. Extensive model studies can be carried out beforehand for this purpose, which simulate the wind turbine in addition to the obstacle which generates the wind disturbance and thus the wind wake, including the weather prediction. The weather prediction or its results can be taken into consideration in corresponding wind models. Such a wake can therefore also be simulated for varying conditions in prior studies.

From these findings and particularly the relationship of the simulated wake and the respectively prevailing conditions, the wake to be expected can be concluded from the conditions in operation. Improvements of such an estimation by way of actual on-site measurements additionally come into consideration.

Moreover, it has been recognized that especially the length of the wind wake can vary strongly depending on the weather property, and at the same time can very significantly influence to what extent a load of the wind turbine is actually present.

According to one aspect, it is proposed that the weather prediction be adapted using a regional weather model at the installation site, wherein the regional weather model describes a relationship between the weather prediction, which is set up for an area going beyond the installation site, and a local weather property at the installation site.

The regional weather model is thus adapted very specifically to the topography and also other boundary conditions such as prevailing air pressure. The regional weather model can establish a relationship between the weather prediction and at least one local weather property. For this purpose, the weather model can be created in prior studies, which can include both simulations and measurements of the installation site. The regional weather model thus supplies a very specific relationship individualized at the installation site. Phenomena on-site and in particular further weather properties to be expected, which influence the wind wake, can thus be determined, in particular predicted. A good foundation for the assessment of the load to be expected at the wind turbine is thus available.

According to one aspect, it is proposed that flow states at the wind turbine which are influenced by the wind wake be estimated in dependence on the weather prediction, in particular in dependence on the weather property, and the throttling down be controlled in dependence on the estimated flow states.

In this case, proceeding from the weather prediction and the weather properties estimated in this case, and of course also based on wind velocity and wind direction, the flow states at the wind turbine are specifically estimated. The regional weather model can also be used for this purpose. It is not absolutely necessary for this purpose to expressly make a statement about the length of the wind wake, but rather the flow situation at the wind turbine can be estimated directly here and the load at the wind turbine can be derived therefrom. Targeted throttling down and in particular targeted refraining from throttling down, at least attenuated throttling down, is thus derivable.

According to one aspect, it is proposed that flow states which are estimated in dependence on the weather prediction additionally be estimated in dependence on at least one local weather model, possibly with further consideration of a or the regional weather model, wherein the local weather model describes a relationship between the weather prediction and flow states expected at the wind turbine.

In particular three weather models are insofar taken into consideration or at least distinguished. The weather prediction, which can also be designated as the comprehensive or global weather prediction, is based on a weather model. This does not necessarily have to be expressly taken into consideration and/or known at all in the control of the wind turbine proposed here. It can be sufficient here to record the results, namely the weather prediction, and take them into consideration.

The regional weather model is focused on the regional area on-site and can especially, with the aid of the weather prediction, thus the global weather prediction, judge atmospheric states on-site. The regional weather model improves a global weather prediction here for the specific site and can thus better predict the atmospheric states on-site. Such atmospheric states on-site can thus be estimated in this way and therefore determined. The mentioned thermal stratification on-site is such a weather property which can be estimated with the aid of the regional weather model.

The local weather model is in turn a model for the specific situation on-site. It can specifically help to compute flow states in certain areas, particularly proceeding from the global weather prediction and the regional weather model.

Especially the local weather model can also be the result of extensive simulations for the situation on-site. Such a local weather model can especially be adapted to a specific wind park. Such a wind park, in which the wind turbine to be controlled stands, can be measured with respect to topography and the installed wind turbines and also the relevant obstacles and the local weather model can be created based thereon. In addition, specific measurements on-site can be incorporated into the local weather model, possibly only later to refine the local weather model. For this purpose, measurements can especially be recorded at the wind turbines on-site with respect to temperature, wind velocity, wind direction, and air pressure. These measurements can be set in a relationship to a weather prediction and/or results from the regional weather model can be produced thereby.

It is particularly to be noted here that the measurement of the installation site for the wind park often takes place before the erection of the wind park. Later measurements having the wind turbines can also take into consideration their influence. Neglecting this, however, measurements by a measuring mast can also be incorporated. This can take place before and/or after erecting the wind park.

Based thereon, thus in particular on the weather prediction, possibly the regional weather model and the local weather model, it is thus possible to determine specific flow states at the wind turbine. The influence of the respectively relevant obstacle is naturally particularly taken into consideration here.

According to one aspect, it is proposed that the local weather model be trained or adapted in ongoing operation of the wind turbine, in particular by ongoing comparison of the weather prediction to flow states detected at the wind turbine. Additionally or alternatively, it is proposed that the local weather model be trained and/or adapted in dependence on historic data. Additionally or alternatively, it is proposed that the local weather model be determined by simulations.

The significance of the local weather model was already described above. It was particularly recognized here that the weather model can be adapted to detect the relationships still better. This is based on the concept, on the one hand, that the model can be improved by a higher number of evaluated situations and those weather relationships. In addition, it also comes into consideration that the situations on-site change. On the one hand, a general climate change comes into consideration for this purpose, which can also be noticeable there. On the other hand, it also comes into consideration that the topography changes, for example, in that the vegetation changes.

The adaptation is proposed in particular in that a comparison be carried out continuously between the weather prediction and flow states detected at the wind turbine. These relationships are thus continuously detected and since they can be depicted in the local weather model, at least partially, the local weather model can be adapted accordingly.

Training in dependence on historic data also comes into consideration, thus measurement data which were recorded earlier, for example, during the surveying of the wind park. The local weather model can thus be created, therefore trained, or adapted when it already exists.

The local weather model can also be determined by simulations as was explained above. The three mentioned partial aspects can also be combined. In particular, initially determining the local weather model by a simulation and then later adapting it by ongoing measurements comes into consideration.

According to one aspect, it is proposed that the estimation of flow states at the wind turbine which are influenced by the wind wake be improved by current measurements at or in the vicinity of the wind turbine. Such current measurements can be carried out easily, especially by existing sensors at the wind turbine or a possibly existing measuring mast, or at other wind turbines. If flow states are at least partially detected by such measurements, they can be compared to the flow states which were estimated. An improvement can then be carried out accordingly and the throttling down can also be adapted if needed.

It is to be noted here that such a measurement at the wind turbine cannot replace the estimation, but it is proposed that the estimation be carried out nonetheless. The estimation is especially required for the purpose of carrying out the throttling down in a timely manner, thus throttling down the wind turbine if necessary, or also not throttling it down, before any damaging situations occur or do not occur.

According to a further aspect, it is proposed that when the wind turbine is installed in a wind park, wakes within the wind park be taken into consideration. It particularly comes into consideration here that such a wake can be the mentioned wind wake, thus that a wind turbine represents the obstacle. It is particularly to be taken into consideration here that the wake or wind wake of a wind turbine is also dependent on the operation of this wind turbine, especially on its speed, its orientation and also the blade angle position. If these variables are taken into consideration, wakes of wind turbines in a wind park can be identified more deliberately and accurately.

One proposal is to influence the obstacle, thus the wind turbine generating the wake, for an energetic observation. It can be checked here whether influencing the wind turbine generating the wake is possibly better for the overall concept of the wind park than adapting the wind turbine in the wake.

According to one aspect, it is proposed that the throttling down of the level be controlled continuously or in multiple steps in dependence on the weather prediction. It was particularly recognized here that the throttling down can also be controlled in level, thus carrying out the throttling down completely or omitting it completely are not the only things that come into consideration. If the weather prediction and the weather property obtained therefrom result in a lower load assumption than would be assumed without consideration of the further weather property, it can thus be provided that the throttling down is only carried out at a lower level, thus with less strength. Throttling down is thus not carried out so strongly. A load reduction can thus be achieved, which only results in a minor energy loss, however.

This throttling down of the level can take place continuously or in multiple steps. Particularly in the case of continuous throttling down, a functional relationship can be provided between the further weather property and the throttling down. For this purpose, for example, the weather property can be assessed by a continuous assessment function, which can in turn be used for the continuous throttling down of the level.

In the case of throttling down the level in multiple steps, in particular three, four, five, or at least six steps are provided. For such steps, the weather property can also be assessed in an equal number of steps. However, a continuous assessment of the weather property can also be used and nonetheless the throttling down of the level can take place in steps. In any case, the wind direction and wind velocity can additionally be taken into consideration. For example, stronger or weaker throttling down can become necessary depending on the wind direction or wind velocity.

According to one aspect, a further wind turbine forms the obstacle and/or the wind turbine to be controlled is one of multiple wind turbines of a wind park, wherein one of the other wind turbines, depending on the wind direction, forms the obstacle. One of the other wind turbines can therefore stand in the same wind park or in an external wind park, or can form an individual turbine.

It was particularly recognized here that such wind disturbances can originate from such adjacent wind turbines, and also such a disturbance caused by an adjacent wind turbine and resulting wind wake can be dependent on the at least one further weather condition. It is therefore proposed that even if a further or one of the other wind turbines forms the obstacle, the throttling down additionally be controlled in dependence on the weather prediction, in particular on the further weather property. Special features of a wind disturbance generated by a wind turbine can also be taken into consideration in this way. The throttling down can be controlled or adapted accordingly.

In some embodiments, a method for planning a wind park including multiple wind turbines is also proposed. Such a method for planning provides that
to estimate an energy production of the wind park to be expected, operation of the wind turbines is simulated for an estimation period of time, in particular a year, wherein for the simulation in each case a
method for operating a wind turbine for generating a settable turbine power is simulated, wherein in the simulated method the wind turbine
includes a rotor having rotor blades adjustable in their blade angle,
is operable at a settable rotor speed, and
is installed at an installation site at a distance to an obstacle wherein the simulation includes that
the obstacle can cause a wind disturbance which can reach the wind turbine as a wind wake in dependence on current wind direction and wind velocity,
the wind turbine reduces its turbine operation by throttling down to protect against loads due to the wind wake,
the throttling down is controlled in dependence on the current wind direction and the wind velocity,
a weather prediction is used to take into consideration at least one further weather property in addition to the wind direction and wind velocity, and
the throttling down is additionally controlled in dependence on the weather prediction, in particular on the further weather property, wherein historic weather data of the installation site are used as the weather prediction.

To plan the wind park, therefore in particular an operation of the wind turbines, thus an operation of the wind park for an estimation period of time, in particular for a year is simulated. This simulation uses typical wind situations as occur in each case distributed over the year at the planned installation site, or at least typically occur. Building thereon, the operation of the wind park and thus the operation of each wind turbine is continuously simulated individually. It is thus simulated how the individual wind turbine and therefore the wind park would behave, from which ultimately power generation results. This is basically simulated through for an estimation period of time, in particular for a complete year. This does not mean that the simulation has to last a complete year but—expressed in simplified terms—is to be simulated through at least all seasons.

A behavior of such a wind turbine in such a wind park, and thus the behavior of the wind park as a whole, includes the consideration of wind disturbances due to obstacles. If this results in the throttling down of a wind turbine, this ultimately also makes itself noticeable in the power production and thus energy production of the wind park. Such behaviors are thus also taken into consideration. It is proposed here that such a behavior also be taken into consideration which does not carry out throttling down exclusively depending on wind direction and wind velocity in relation to a specific obstacle. Instead, a behavior according to at least one above-explained aspect of the method for controlling the wind turbine is fundamentally taken into consideration or simulated here.

It is thus taken into consideration that possibly a wind turbine would not be throttled down or would not be throttled down excessively strongly. This has effects on the power production and therefore energy production and therefore overall a changed assumed energy production of the wind park results, which can also be designated as AEP (Annual Energy Production).

The planning method thus takes into consideration that an improved control method is used in the park to be planned. It is especially to be taken into consideration here that the simulations accordingly have to be made capable of taking into consideration this improved control, because it is based on the consideration of the further weather condition or weather conditions from a weather prediction. This information thus also additionally has to be recorded and taken into consideration in the planning or in the corresponding simulation.

According to one aspect, it is proposed that to simulate an operation of a wind turbine, in each case a method for operating a wind turbine according to one of the above-explained aspects of the method for operation is simulated.

In particular, it is provided that historic weather data be used for the weather prediction which the method for operation uses. Furthermore, it is proposed that the local weather model be trained or adapted in dependence on historic data and/or that the local weather model be determined by simulations. In this way, it is possible to create a local weather model already even for the wind park which is still to be planned, thus does not yet exist, and at least take it into consideration in the calculation of the annual energy production.

Additionally or alternatively, it is proposed, in the estimation of flow states at the wind turbine which are influenced by the wind wake, that historic measured values be used instead of current measurements used for improvements at or in the vicinity of the wind turbine. In the planning of the wind park, the behavior of the improved throttling down can thus even be taken into consideration in view of such improvements which would be achieved in later operation by current measurements at or in the vicinity of the wind turbine. Such measurements are not possible in the wind park planning, since the wind turbine is not yet erected. However, values corresponding to such measurements can be determined by simulation from historic measured values, thus in particular those which were recorded during the surveying of the installation site. The behavior of the method for operating a wind turbine can thus even be taken into consideration for this special improvement by current measurements for the wind park planning.

In some embodiments, a wind turbine is also proposed which is provided for generating a settable turbine power. The wind turbine
includes a rotor having rotor blades adjustable in their blade angle,
is operable at a settable rotor speed, and
is installed at an installation site at a distance to an obstacle wherein
the obstacle can cause a wind disturbance which can reach the wind turbine as a wind wake in dependence on current wind direction and wind velocity,
wherein the wind turbine is prepared for the purpose of being operated using a method which
reduces the wind turbine in its turbine operation by throttling down to protect against loads by the wind wake, wherein
the throttling down is controlled in dependence on the current wind direction and the current wind velocity,
a weather prediction is used in order to take into consideration at least one further weather property in addition to the wind direction and wind velocity
the throttling down is additionally controlled in dependence on the weather prediction, in particular on the further weather property, wherein
the control of the throttling down is implemented on a throttling down control unit and the wind turbine includes this throttling down control unit, or is coupled thereto, or includes an interface for coupling with the throttling down control unit.

Such a wind turbine is therefore operated using a method which carries out throttling down as was explained according to at least one above-described embodiment. The method is implemented for this purpose on a throttling down control unit. Such a throttling down control unit can be a process computer, individual method parts can also be implemented distributed on multiple parts of a control unit. The throttling down control unit can also be part of a turbine controller of the wind turbine, or a turbine controller can form the throttling down control unit, in particular if the method is implemented on the turbine controller.

The method for controlling the throttling down can particularly be provided as a sequence program and can be implemented on the throttling down control unit or a process computer provided there.

The throttling down control unit can be part of the wind turbine, but it can also be provided that it is provided separately, in particular in a central park computer if the wind turbine is installed in a wind park. In this case, the wind turbine is coupled with the throttling down control unit, in particular via a corresponding interface. Such an interface can receive and transmit signals which are required for the method and were described above according to at least one embodiment.

Such a throttling down control unit is also proposed according to some embodiments. This is prepared to control the throttling down of a wind turbine and can be coupled accordingly with the wind turbine to be throttled down for this purpose. It operates according to a method according to one of the above-described embodiments, wherein such a method can be implemented in the throttling down control unit in a process computer, in particular as a computer program.

The advantages of such a throttling down control unit result from the above explanations. In particular, the throttling down of a wind turbine can be controlled thereby, wherein the method can be provided on the throttling down control unit for this purpose in a simple manner. A simple possibility for using the method for arbitrary wind turbines also results. For this purpose, uniform throttling down control units can be provided, which are then solely to be adapted to the respective special features of the wind turbine to be controlled, in particular the respectively individual obstacle is to be taken into consideration in accordance with its site and its quality.

A wind park having multiple wind turbines is also proposed in some embodiments. According to one aspect, such a wind park includes at least one wind turbine to be controlled as described herein, in particular one on which a method for operating a wind turbine according to one of the above-described embodiments is implemented or is applied.

Additionally or alternatively, the wind park includes a park controller, which comprises an above-described throttling down control unit. The control of the throttling down can thus take place centrally via the park controller. The park controller can also comprise the throttling down control unit in that the functionality is implemented in a process computer of the park controller.

According to one aspect, it is proposed that the wind park include communication means for communication among the wind turbines in order to control the throttling down of a first wind turbine in dependence on a second wind turbine, in particular if the second wind turbine forms the obstacle for the first wind turbine. Such a communication can take place centrally via the park computer of the wind park. In particular, measurement data about flow states at the respective wind turbine can also be transmitted here. It is thus also possible, which is proposed here as a separate aspect, to control the wind turbine to be controlled and thus possibly to be throttled down in dependence on the operation of the wind turbine which forms the obstacle and thus to throttle it down depending thereon.

### BRIEF DESCRIPTION OF THE SEVERAL VIEWS OF THE DRAWINGS

Embodiments of the invention are explained in more detail hereinafter by way of example on the basis of embodiments with reference to the appended figures.

FIG. 1 shows a wind turbine in a perspective view.

FIG. 2 shows a wind park in a schematic illustration.

FIG. 3 schematically shows an obstacle situation for two wind directions in a top view.

FIG. 4 schematically illustrates the effect of a thermal air stratification on an obstacle situation for two examples.

FIG. 5 shows a schematic flow chart for implementing a proposed method.

### DETAILED DESCRIPTION

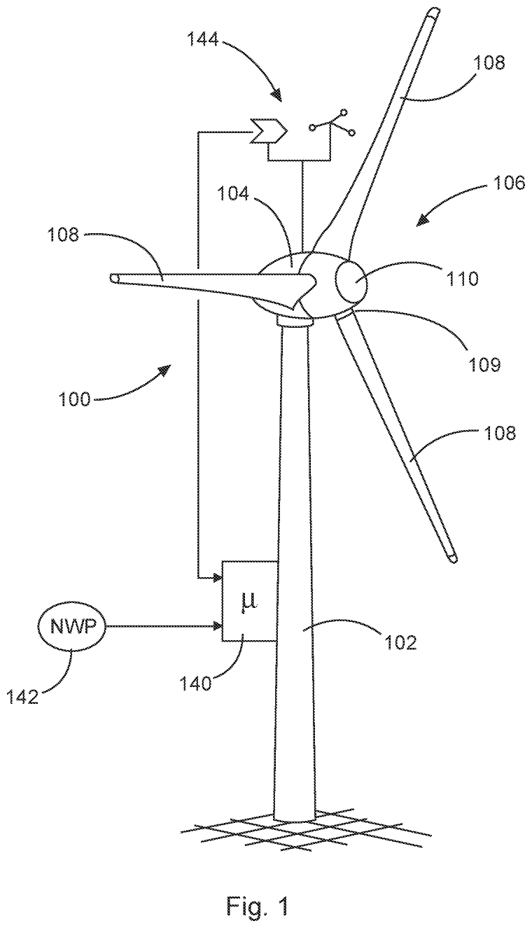

FIG. 1 shows a schematic illustration of a wind turbine according to some embodiments. The wind turbine 100 includes a tower 102 and a nacelle 104 on the tower 102. An aerodynamic rotor 106 having three rotor blades 108 and a spinner 110 is provided on the nacelle 104. The aerodynamic rotor 106 is set into a rotational movement in operation of the wind turbine by the wind and thus also rotates an electrodynamic rotor or impeller of a generator, which is coupled directly or indirectly with the aerodynamic rotor 106. The electrical generator is arranged in the nacelle 104 and generates electrical energy. The pitch angle of the rotor blades 108 can be changed by pitch motors at the rotor blade roots 109 of the respective rotor blades 108.

Moreover, a turbine controller 140 is schematically shown in FIG. 1, which is shown outside the tower 102 only for reasons of illustration. The turbine controller 140 can be arranged in the tower 102 and/or in the nacelle 104. It also comes into consideration that a division is provided, so that one part of the turbine controller is located in the tower 102 and another part is located in the nacelle.

The method for operating the wind turbine and in particular for throttling down the operation of the wind turbine can be implemented in the turbine controller 140. For this purpose, the turbine controller can receive a weather prediction from an external weather model 142. This is schematically indicated in FIG. 1 and such weather data of the weather prediction can be transmitted to the turbine controller via radio and/or by a SCADA.

The turbine controller additionally receives sensor data from sensors 144, for which an anemometer having a wind vane is shown here by way of example and as an illustration. The turbine controller insofar actually uses information regarding wind velocity and wind direction for throttling down. However, this information can also be ascertained in another way. For the wind direction, it comes into consideration in particular that it is provided to the turbine controller in any case and/or the current azimuth orientation of the wind turbine is used instead of the wind direction. The current azimuth orientation of the wind turbine can in turn be dependent on the wind direction detected by the wind vane.

The current wind velocity can be used as a measured value by the anemometer or another sensor, for which the anemometer also stands as a representation, or it can be estimated from turbine data such as speed, power, and blade angle.

It is additionally proposed that specific flow conditions at the wind turbine 100 be detected, which also provides sufficient information for detecting turbulence. Further sensors can be provided for this purpose, for which the sensors 144 are also to stand as a representation.

Regional and/or local weather models can also be implemented in the turbine controller, which can improve the data of the weather model 142. The regional weather model can particularly be provided for the purpose of giving the data of the weather model 142 a higher resolution. The local weather model can particularly be provided for depicting a specific situation at the wind turbine 100.

Moreover, the turbine controller 140 can contain the information about the obstacle. Particularly in the case of fixed obstacles, corresponding information can already be stored as one-time information during the erection of the wind turbine. However, transmitting such information again regularly also comes into consideration.

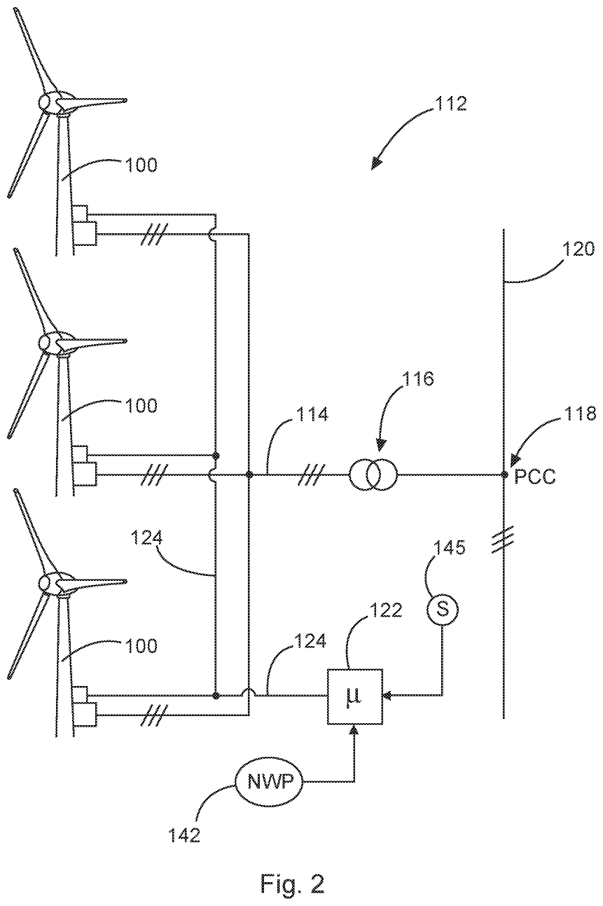

FIG. 2 shows a wind park 112 having three wind turbines 100 by way of example, which can be identical or different. The three wind turbines 100 are thus representative for a fundamentally arbitrary number of wind turbines of a wind park 112. The wind turbines 100 provide their power, namely in particular the generated current, via an electrical park grid 114. The respectively generated currents or powers of the individual wind turbines 100 are added up here and a transformer 116 is usually provided, which steps up the voltage in the park in order to then feed it into the supply grid 120 at the feed point 118, which is also designated in general as a PCC. FIG. 2 is only a simplified illustration of a wind park 112. For example, the park grid 114 can be designed differently in that, for example, a transformer is also provided at the output of each wind turbine 100, to name only one other embodiment.

The wind park 112 moreover includes a central park computer 122, which can also be designated synonymously as a central park controller. This can be connected via data lines 124, or wirelessly, to the wind turbines 100, in order to exchange data with the wind turbines via this and in particular to receive measured values from the wind turbines 100 and transmit control values to the wind turbines 100.

According to one variant, the throttling down of one of the wind turbines 100 can be implemented on the central park computer 122. Throttling down for several of the wind turbines can also be implemented here, wherein individual throttling down is carried out in each case for each wind turbine and insofar an individual method is at least partially implemented in each case. The methods can take into consideration common features, however, in particular the ascertainment of the at least one further weather property can be identical for all wind turbines, since such a further weather property applies in the same way to the entire wind park, depending on the park size.

The park computer 122 can insofar comprise a throttling down control unit. The throttling down control unit can form a separate physical unit or can be implemented as program code on the park computer. The park computer or the throttling down control unit also includes interfaces for this purpose in order to be able to receive weather data of a weather model 142.

The central park computer 122, which can also be designated in simplified and synonymous form as a park computer, moreover receives sensor data from a sensor arrangement 145. The sensor arrangement 145 can be a measuring mast in the wind park. However, it is also conceivable that sensor data are received from the wind turbines. The park computer 122 can receive sensor data from the wind turbines, and also other data from the wind turbines, via the data lines 124. The park computer can also control the wind turbines via the data lines 124.

The park computer 122 can contain a park controller or the park computer 122 can also be designated as a park controller.

If the throttling down is controlled by the park computer 122, it ascertains the at least one further weather property. This possibly takes place individually for each affected wind turbine, namely in each case via the knowledge of a relevant obstacle. A weather prediction is thus also used here in order to take into consideration at least one further weather property in addition to the wind direction and wind velocity. This is insofar to be understood generally so that the weather prediction provides the further weather property as information, or this further weather property is derived from the information which the weather prediction provides. The park computer 122 derives a provided throttling down therefrom and can transmit this as a throttling down signal via the data lines 124 to each of the affected wind turbines, which then implement the throttling down for themselves.

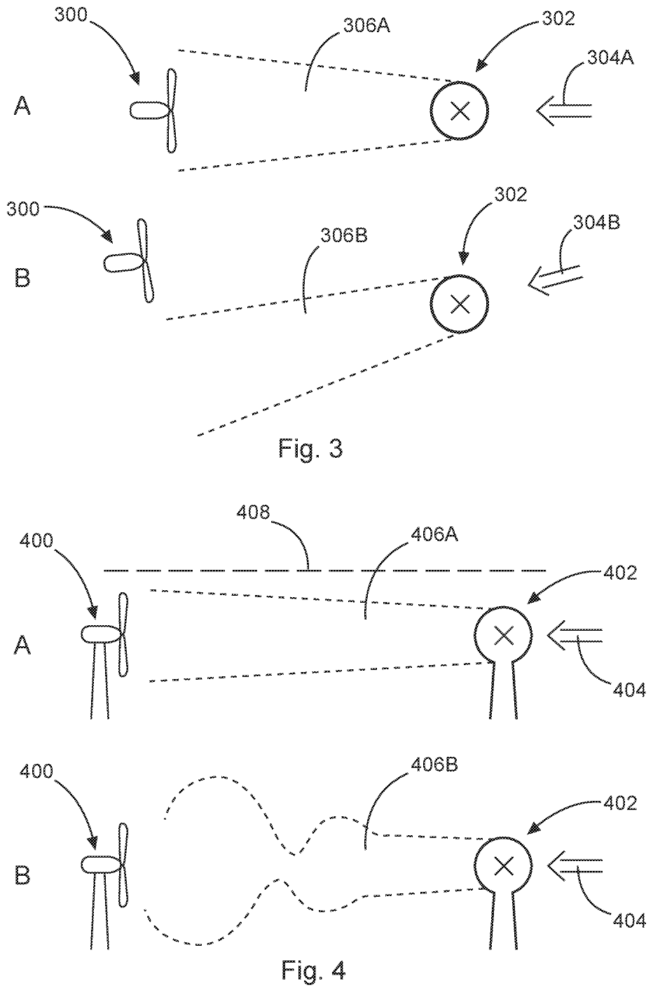

FIG. 3 illustratively explains the problem occurring due to an obstacle for a wind turbine. FIG. 3 shows two top views A and B, each of a wind turbine 300 and an obstacle 302, which is only schematically shown here and can be representative for various obstacles. The obstacle can be a wind turbine, a tree or a building or also a hill, or a forest, in order to only mention several examples.

The two illustrations A and B differ in the prevailing wind direction 304 A and 304 B, respectively.

In illustration A, the wind direction 304 A has the result that a wind wake 306 A induced by the obstacle 302 reaches the wind turbine 300. The wind wake 306 A is insofar schematically shown by two delimiting dashed lines.

In illustration A, the wind wake 306 A thus reaches the wind turbine 300 and in this way turbulence can especially occur at the wind turbine 300, which can damage it.

With the somewhat different wind direction 304 B of illustration B, the obstacle 302 also induces a wind wake 306 B, which does not reach the wind turbine 300, however, and therefore does not result in damaging turbulence at the wind turbine 300. The wind turbine 300 therefore does not need to be throttled down.

The illustration in FIG. 3 explains a fundamentally known situation having known solution. It has the result that for the situation of illustration A, thus whenever the wind direction 304 A is present, the wind turbine 300 is throttled down. Of course, this also takes place in dependence on the wind velocity, because no relevant damage to the wind turbine 300 is to be expected at low wind velocities.

However, it has now been recognized that the illustrated wind direction 304 A, even with sufficiently strong wind, does not have to result in a particularly large load due to the wind wake 306 A at the wind turbine 300. It has been recognized that at least one further weather property can have an influence and should therefore be taken into consideration.

One such weather property is a thermal stratification, which is illustrated in FIG. 4. The thermal stratification between air layers is illustrated by a horizontal thermal boundary layer 408. FIG. 4 therefore shows in each of illustrations A and B a side view of a wind turbine 400 and an obstacle 402. The wind turbine 400 can correspond to the wind turbine 300 of FIG. 3, and moreover also a wind turbine 100 of FIG. 1 or FIG. 2. The obstacle 402 can correspond to the obstacle 302 of FIG. 3. Wind having a wind direction 404 is also shown. The wind direction 404 can correspond to the wind direction 304 A according to FIG. 3. The wind direction 404 is thus such that a wind wake 406 A or 406 B originating from the obstacle 402 is initially directed in the direction toward the wind turbine 400.

Particularly with a flat landscape and the thermal boundary layer 408 shown in illustration A, the wind wake 406 A can reach the wind turbine 400. This is especially a situation which is to be expected with flat terrain. If the region is thus flat, therefore not mountainous, and if strong thermal stratification is present, which is symbolized here by the thermal boundary layer 408, it is to be expected that the wind wake 406 A will reach the wind turbine 400.

In the illustration according to Figure B, no thermal boundary layer is shown and a case is therefore illustrated here in which no or only minor thermal stratification of the air masses of the atmosphere is present. This can have the result that the wind wake 406 B does not reach the wind turbine 400 or reaches it more weakly in comparison to situation A. Only for illustration, the wind wake 406 B is shown for this purpose so that originating from the obstacle 402 toward the wind turbine 400 it is resolved more and more strongly, for example, itself has turbulence, so that a clear or a long clear wind wake does not result.

The illustration of FIG. 4 of situation B is insofar only to be understood as illustrative, however, and is not supposed to reflect the actually occurring weather phenomena. It should be made clear that in spite of the same wind direction 404 and same wind strength assumed in FIG. 4, in one case the wind wake 406 A reaches the wind turbine 400, but in the other case the wind wake 406 B does not reach the wind turbine 400. Of course, it also comes into consideration that the wind wake 406 B only reaches the wind turbine 400 more weakly. In any case, it reaches the wind turbine 400 so much more weakly that this turbine has to be throttled down less or not at all in comparison to the situation according to FIG. 4, illustration A.

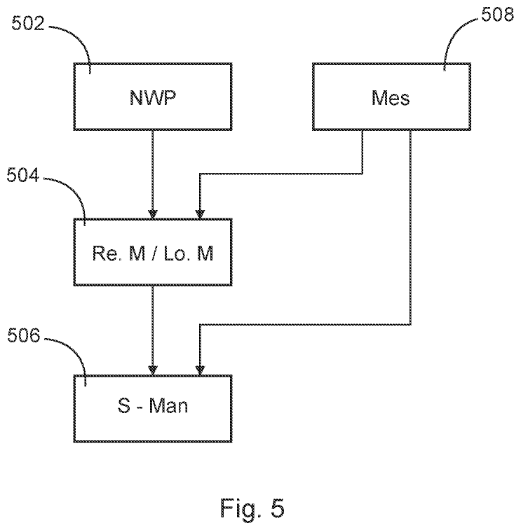

FIG. 5 explains a sequence for throttling down a wind turbine. The sequence 500 basically begins with the weather prediction step 502. Accordingly, a numeric weather prediction is provided. The physical variables which influence the occurrence of damaging flow states can be obtained in time and space thereby. Weather predictions can be provided in the form of current numerical weather predictions (NWP).

For improvement, such weather predictions can be coupled with a regional weather model, which is carried out in refining step 504. In the refining step, a regional weather model can therefore be present in order to also achieve a higher resolution. Future weather models can possibly provide a higher resolution, so that the regional weather model or a local weather model could be superfluous.

It is therefore especially proposed that the weather model, which has a low spatial resolution, be upgraded in refining step 504. It is especially proposed that an additional method be applied in order to obtain a prediction of the flow at the turbine position. Such methods establish a relationship between the results of the weather models and the damaging flow states to be expected for the turbines. The relationship between the results of the weather models and the flow state at the turbines can be ascertained by prefinished simulations.

Such simulations can be designated as RANS or LES. Statistical models can also be used.

In addition to a regional weather model, a local weather model, which stands for the mentioned methods which result in more accurate flow conditions at the turbine, can insofar also be used in the refining step.

Finally, the results are passed on at throttling down step 506, which derives the specific throttling down from the data. The throttling down step therefore stands for the application of a weather-related sector management at the turbine. The prediction quality of the models which are described in weather prediction step 502 or refining step 504 can additionally be improved by measurements, for example, from measuring masts located in the vicinity of the turbine or LIDAR systems installed on the turbine.

The recorded data can be incorporated via a SCADA system of the turbine into the regulation strategy. SCADA data can therefore also be discussed here. An optimization of the prediction quality can thus be carried out by training of the base model using historic data. In addition, a live optimization, thus an online optimization in ongoing operation of the prediction quality by fusing the current prediction with live data comes into consideration. In these two cases, thus the optimization of the prediction quality and the live optimization, methods of machine learning are used for the optimization.

The mentioned sensor data can therefore be incorporated by sensor step 508, which only stands as an example here for the recording of measurement data. Other measurement data such as wind direction and wind velocity can also be recorded in the measuring step and can each be incorporated.

According to some embodiments, particularly the following was recognized or the following is proposed.

Some embodiments can be used for ongoing operation and for park planning. For an application in ongoing operation of existing turbines/parks, the proposed algorithm especially includes three steps:

Step A1: providing the numeric weather prediction: The physical variables which influence the occurrence of harmful or damaging flow states in time and space can be obtained thereby. Weather predictions can be used in the form of:
a) current numerical weather predictions (NWP), and/or
b) current NWP models, coupled with a regional weather model (in English mesoscale coupling).

Future weather models, which are expected to be resolved in scale, thus have a high resolution, can then also be used.

Step A2: Since the weather models described in step A1 under a) and b) have a low spatial resolution, it is proposed that additional methods be applied to obtain a prediction of the flow at the turbine position. These methods represent a relationship between the results of the weather models and the harmful or damaging flow states to be expected for the turbines. The relationship between the results of the weather models and the flow state at the turbines can be established by prefinished RANS or LES simulations. Statistical models can also be used.

Step A3: Applying the weather-related sector management at the turbine. The prediction quality of the models which are described in step A1 and step A2 can additionally be improved by measurements such as i) from measuring masts located in the vicinity of the turbine or ii) LIDAR systems installed on the turbine or iii) can be incorporated into the SCADA data of the turbine itself and into the regulation strategy, by the following measures:
a) optimization of the prediction quality by training the base model using historic data
b) live optimization of the prediction quality by fusing the current prediction with live data

In both cases A3 a) and A3 b), methods of machine learning can be used for the optimization.

For the application in park planning, historic weather predictions for the site in question are used instead of current weather predictions. Step A1 and step A2 remain essentially unchanged here.

In a step B3 deviating from step A3, the effect of the sector management can then be simulated in order to quantify the increase of the AEP or the service life.

The regulation algorithms can be integrated into the turbine controllers or into the park controller.

After integration into a controller, the method can be used to achieve more power in ongoing operation or lengthening of the service life of the turbines.

The adaptations of the controller can also already be taken into consideration in the park planning phase. A quantification of the AEP thus increased or the service life thus increased can be used to reduce the electricity production costs.

A maximum current production or service life can be achieved by an adaptation of the controller to the conditions prevailing at the respective site. Some embodiments provide throttling down in dependence on the wind direction and is insofar sectorial throttling down and the throttling down can therefore be designated as sector management. However, in addition to the wind velocity, a further weather property is taken into consideration, so that an additional condition is present, and the method can therefore be designated as conditional sector management. This conditional sector management results in lower costs due to the consideration of this additional condition.

Due to the prediction of harmful or damaging flow states for the turbine, the turbines can be throttled down at points in time at which these harmful states or states damaging the turbine occur with high probability. In contrast, the turbines can be moved into a mode of increased power production when these harmful states or states damaging the turbine occur with a low probability. Such a regulation strategy or control strategy is reasonable against the background of the fact that loads with high amplitude are incorporated exponentially in the consumption of the service life. The power or the service life can be maximized by such a regulation strategy and the electricity production costs can thus be reduced.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. A method for operating a wind turbine for generating a settable turbine power, wherein the wind turbine:
includes a rotor having rotor blades adjustable in their blade angle,
is operable at a settable rotor speed, and
is installed at an installation site at a distance to an obstacle,
wherein the method comprises:
the obstacle causing a wind disturbance, which, in dependence on current wind direction and wind velocity, can reach the wind turbine as a wind wake, and
the wind turbine reducing its turbine operation by throttling down for protection against loads due to the wind wake,
wherein the throttling down is controlled in dependence on the current wind direction and the current wind velocity,
wherein a weather prediction is used in order to take into consideration at least one further weather property in addition to the wind direction and wind velocity, and
wherein the throttling down is additionally controlled in dependence on the weather prediction.

2. The method as claimed in claim 1, wherein:
the further weather property is estimated in dependence on the weather prediction, and/or
the further weather property is a thermal stratification of atmospheric boundary layers, and
the throttling down is controlled in dependence on the thermal stratification.

3. The method as claimed in claim 1, wherein
the throttling down is controlled in dependence on a thermal stratification so that
an area surrounding the wind turbine is classified as flat land or mountainous land, and
in the case of classification as flat land, throttling down is carried out more the weaker mixing is between boundary layers and/or the more stable the thermal stratification is, and
in the case of classification as mountainous land, throttling down is carried out less the weaker mixing is between boundary layers and/or the more stable the thermal stratification is.

4. The method as claimed in claim 1, wherein for throttling down:
the turbine power is reduced,
the rotor speed is reduced, and/or
the blade angle of each rotor blade is adjusted in the direction toward a vane position.

5. The method as claimed in claim 1, wherein:
a length of the wind wake is estimated in dependence on the weather prediction; and
the throttling down is controlled in dependence on the estimated length of the wind wake.

6. The method as claimed in claim 5, wherein the length of the wind wake is estimated in dependence on the weather property.

7. The method as claimed in claim 1, wherein
the weather prediction is adapted using a regional weather model at the installation site, wherein:
the regional weather model describes a relationship between the weather prediction, which is created for an area going beyond the installation site, and a local weather property at the installation site, and/or wherein:
flow states at the wind turbine, which are influenced by the wind wake, are estimated in dependence on the weather prediction, and
the throttling down is controlled in dependence on the estimated flow states.

8. The method as claimed in claim 7 wherein the flow states at the wind turbine are estimated in dependence on the weather property.

9. The method as claimed in claim 1, wherein
flow states which are estimated in dependence on the weather prediction
are additionally estimated in dependence on at least one local weather model, possibly with further consideration of a regional weather model, wherein:
a local weather model describes a relationship between the weather prediction and flow states expected at the wind turbine.

10. The method as claimed in claim 1, wherein:
a local weather model
is trained and/or adapted in ongoing operation of the wind turbine by ongoing comparison of the weather prediction to flow states detected at the wind turbine, and/or
is trained and/or adapted in dependence on historic data, and/or
is determined by simulations and/or
an estimation of flow states at the wind turbine, which are influenced by the wind wake, is improved by current measurements at or in the vicinity of the wind turbine and/or
if the wind turbine is installed in a wind park, wakes within the wind park are taken into consideration.

11. The method as claimed in claim 1, wherein:
the throttling down of the level is controlled continuously or in multiple steps in dependence on the weather prediction, and/or wherein:
a further wind turbine forms the obstacle, and/or
the wind turbine is one of multiple wind turbines of a wind park, and
one of the other wind turbines, depending on the wind direction, forms the obstacle.

12. The method as claimed in claim 1, wherein the throttling down is additionally controlled in dependence on the further weather property.

13. A method for planning a wind park including multiple wind turbines, comprising:
estimating an energy production to be expected of the wind park by simulating operation of the wind turbines for an estimation period of time, wherein for the simulation in each case:
operation of a wind turbine for generating a settable turbine power is simulated, wherein, in the simulation, the wind turbine
includes a rotor having rotor blades adjustable in their blade angle,
is operable using a settable rotor speed, and
is installed at an installation location at a distance to an obstacle,
wherein simulating operation of a wind turbine includes:
the obstacle causing a wind disturbance, which, in dependence on current wind direction and wind velocity, can reach the wind turbine as a wind wake, and
the wind turbine reducing its turbine operation by throttling down for protection against loads due to the wind wake,
wherein the throttling down is controlled in dependence on the current wind direction and the wind velocity,
wherein a weather prediction is used in order to take into consideration at least one further weather property in addition to the wind direction and wind velocity, and
the throttling down is additionally controlled in dependence on the weather prediction, wherein historic weather data of the installation site are used as the weather prediction.

14. The method as claimed in claim 13, wherein:
the estimation period of time is one year; and
the throttling down is additionally controlled in dependence on the further weather property.

15. The method as claimed in claim 13, wherein:
for the simulation of an operation of a wind turbine, in each case:
historic weather data are used for the weather prediction,
a local weather model
is trained or adapted in dependence on historic data, and/or
is determined by simulations and/or
in an estimation of flow states at the wind turbine, which are influenced by the wind wake, historic measured values are used instead of current measurements at or in the vicinity of the wind turbine, which are used for improvements.

16. A wind turbine for generating a settable turbine power, and the wind turbine comprising:
a rotor having rotor blades adjustable in their blade angle,
wherein the wind turbine is operable at a settable rotor speed, and
wherein the wind turbine is installed at an installation site at a distance to an obstacle;
wherein:
the obstacle can cause a wind disturbance which, in dependence on current wind direction and wind speed, can reach the wind turbine as a wind wake,
wherein the wind turbine is configured to be operated using a method in which:
the wind turbine reduces its turbine operation by throttling down for protection against loads due to the wind wake, wherein
the throttling down is controlled in dependence on the current wind direction and the current wind velocity,
a weather prediction is used in order to take into consideration at least one further weather property in addition to the wind direction and wind velocity, and
the throttling down is additionally controlled in dependence on the weather prediction, wherein:
the control of the throttling down is implemented on a throttling down control unit and the wind turbine includes this throttling down control unit or is coupled thereto or includes an interface for coupling with the throttling down control unit.

17. The wind turbine as claimed in claim 16, wherein the throttling down is additionally controlled in dependence on the further weather property.

18. The wind turbine as claimed in claim 16, further comprising:
a throttling down control unit, prepared to control the throttling down of the wind turbine.

19. A wind park having multiple wind turbines, the wind park comprising:
at least one wind turbine as claimed in claim 16, and
a park controller, which comprises a throttling down control unit prepared to control throttling down of the wind turbines.

20. The wind park as claimed in claim 19, wherein:
the park controller is configured to communicate with the wind turbines, in order to control the throttling down of a first wind turbine in dependence on a second wind turbine,
if the second wind turbine forms the obstacle for the first wind turbine.
